(19) United States
(12) Patent Application Publication
(10) Pub. No.: US 2014/0142895 A1
(43) Pub. Date: May 22, 2014

(54) EXTRACTING AND INFERRING MAP METADATA FROM ARCHITECTURAL DIAGRAMS

(71) Applicant: QUALCOMM INCORPORATED, San Diego, CA (US)

(72) Inventors: Abhinav Sharma, Santa Clara, CA (US); Saumitra Mohan Das, Santa Clara, CA (US); Chandrakant Mehta, Santa Clara, CA (US)

(73) Assignee: QUALCOMM Incorporated, San Diego, CA (US)

(21) Appl. No.: 13/679,740

(22) Filed: Nov. 16, 2012

(51) Int. Cl. G06F 17/50

(52) U.S. Cl. CPC G06F 17/5004
USPC 703/1

(57) ABSTRACT

Systems, apparatus and methods for converting an architectural diagram to structural elements (e.g., such as walls, hallways and open areas) for forming assistance data are presented. An architectural diagram may contain too many layers to manually review each layer. Some examples disclosed herein sort layers of an architectural diagram based on if the layer probably contains structural elements useful for forming assistance data. The sorted list of layers may be user selectable or automatically incorporated into a floor plan containing only structural elements. Once a floor plan is created from an architectural diagram, assistance data may be created and sent to a mobile device.

### CROSS-REFERENCE TO RELATED APPLICATIONS

This is the first application filed for the present technology.

This application is related to U.S. patent application Ser. No. 13/679,747, entitled “Processing and managing multiple maps for an LCI” filed Nov. 16, 2012, having Atty Docket 122385, and which is incorporated herein by reference.

### BACKGROUND

I. Field of the Invention

This disclosure relates generally to systems, apparatus and methods for generating assistance data for wireless users, and more particularly to converting a multi-level architectural diagram to structural elements (e.g., walls, door openings, staircases, elevators, escalators) by extracting and inferring map metadata from the architecture diagrams to create assistance data.

II. Background

Architectural diagrams are usually complex and overlap several separate layers. The separate layers may include a layer for each of exterior walls, interior support walls, temporary (non-support) walls, elevators, partitions, chairs and tables, filing cabinets, office plants, wall decorations, hot/cold water plumbing, drain plumbing, gas plumbing, built-in electrical lighting, hanging electrical lighting, electrical switches, electrical wiring, electrical 210 Volt-AC outlets, electrical 110 Volt-AC outlets, heating & cooling ducting, heating & cooling vents, windows, desk items, book shelves and heavy equipment. Besides separate layers existing for each floor, separate layers may exist for each wing or section of a building. For example, one layer may represent heating ducts on the second floor of the west wing of a particular building. Another layer may represent structural walls for the third floor.

A complex architectural diagram may include dozens to 100 or more separate layers. It may be labor intensive to impossible to view each layer and search metadata to find which layers represent layers that are useful to create assistance data. Therefore, a method is needed to extract structural information and metadata from architectural diagrams to create assistance data.

### BRIEF SUMMARY

Systems, apparatus and methods for converting an architectural diagram to structural elements (e.g., such as walls, hallways and open areas) for forming assistance data are presented. An architectural diagram may contain too many layers to manually review each layer. Some examples disclosed herein sort layers of an architectural diagram based on if the layer probably contains structural elements useful for forming assistance data. The sorted list of layers may be user selectable or automatically incorporated into a floor plan containing only structural elements. Once a floor plan is created from an architectural diagram, assistance data may be created and sent to a mobile device.

According to some aspects, disclosed is a method, system and device to convert an architectural diagram to structural elements of a floor plan for forming assistance data

According to some aspects, disclosed is a method for converting an architectural diagram to structural elements for forming assistance data, the method comprising: providing the architectural diagram in electronic format, comprising multiple layers and metadata; identifying a subset containing structural layers from the multiple layers; removing door arches from a door layer in the subset; and concatenating the subset to create a floor plan containing the structural elements.

According to some aspects, disclosed is a device for converting an architectural diagram to structural elements for forming assistance data, the device comprising a processor and memory comprising code, when executed by the processor, to: provide the architectural diagram in electronic format, comprising multiple layers and metadata; identify a subset containing structural layers from the multiple layers; remove door arches from a door layer in the subset; and concatenate the subset to create a floor plan containing the structural elements.

According to some aspects, disclosed is a device for converting an architectural diagram to structural elements for forming assistance data, the device comprising: means for providing the architectural diagram in electronic format, comprising multiple layers and metadata; means for identifying a subset containing structural layers from the multiple layers; means for removing door arches from a door layer in the subset; and means for concatenating the subset to create a floor plan containing the structural elements.

According to some aspects, disclosed is a device for converting an architectural diagram to structural elements for forming assistance data comprising a processor and memory wherein the memory includes software instructions to: provide the architectural diagram in electronic format, comprising multiple layers and metadata; identify a subset containing structural layers from the multiple layers; remove door arches from a door layer in the subset; and concatenate the subset to create a floor plan containing the structural elements.

According to some aspects, disclosed is a non-volatile computer-readable storage medium including program code stored thereon for a device for converting an architectural diagram to structural elements for forming assistance data, comprising program code to: provide the architectural diagram in electronic format, comprising multiple layers and metadata; identify a subset containing structural layers from the multiple layers; remove door arches from a door layer in the subset; and concatenate the subset to create a floor plan containing the structural elements.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWING

Embodiments of the invention will be described, by way of example only, with reference to the drawings.

FIG. 1 illustrates an architectural diagram including multiple layers.

FIG. 2 shows translating an architectural diagram to assistance data, in accordance with some embodiments of the present invention.

FIGS. 3 and 4 show an example of an architectural diagram and a resulting floor plan, in accordance with some embodiments of the present invention.

FIG. 5 shows a method to convert an architectural diagram to structural elements for forming assistance data, in accordance with some embodiments of the present invention.

FIG. 6 shows a device to convert an architectural diagram to structural elements for forming assistance data, in accordance with some embodiments of the present invention.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the disclosure.

Position determination techniques described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs). For example, a SV in a constellation of Global Navigation Satellite System (GNSS) such as Global Positioning System (GPS), Galileo, GLONASS or Compass may transmit a signal marked with a PN code that is distinguishable from PN codes transmitted by other SVs in the constellation (e.g., using different PN codes for each satellite as in GPS or using the same code on different frequencies as in GLONASS). In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

As used herein, a mobile device, sometimes referred to as a mobile station (MS) or user equipment (UE), such as a cellular phone, mobile phone or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

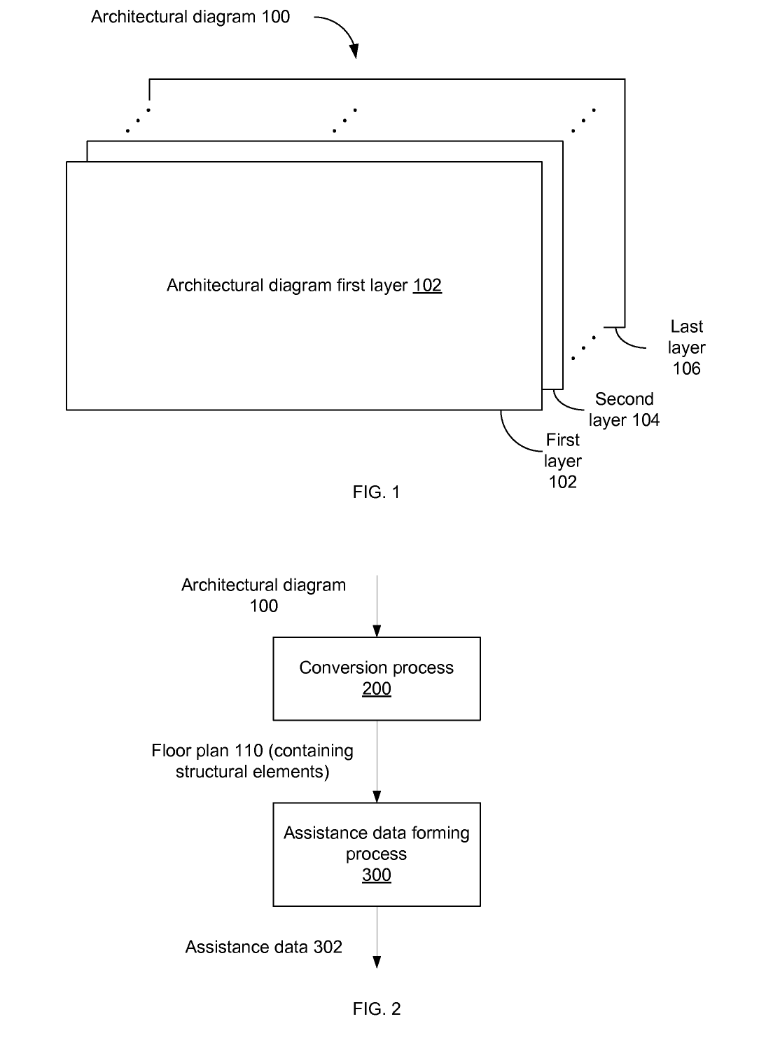

FIG. 1 illustrates an architectural diagram 100 that including multiple layers. Some architectural diagrams 100 contain between 100 and 200 layers. As shown, an architectural diagram 100 contains a first layer 102, a second layer 104 and so on until a last layer 106. The architectural diagram 100 may contain a separate layer for each of exterior walls, interior support walls, temporary (non-support) walls, elevators, partitions, chairs and tables, filing cabinets, office plants, wall decorations, hot/cold water plumbing, drain plumbing, gas plumbing, built-in electrical lighting, hanging electrical lighting, electrical switches, electrical wiring, electrical 210 Volt-AC outlets, electrical 110 Volt-AC outlets, heating & cooling ducting, heating & cooling vents, windows, desk items, book shelves and heavy equipment. Layers may also contain metadata, such as labels of items, objects and structures in a layer as well as layer titles and labels and layer names.

FIG. 2 shows translating an architectural diagram 100 to assistance data 302, in accordance with some embodiments of the present invention. The architectural diagram 100 contains structural elements (e.g., walls and doorways) and non-structural elements (e.g., desks and HVAC vents). A conversion process 200 translates an architectural diagram 100 into a floor plan 110 containing just structural elements. The structural elements include, for example, walls, hallways, doorways, stairs and elevators. The floor plan 110 may be used by an assistance data forming process 300 to form assistance data 302. In other words, the floor plan 110 defines walls, pathways and common areas for a mobile user. The assistance data forming process 300 may use the positions of walls and pathways to help determine RF propagation. The assistance data forming process 300 may also use the walls, pathways and common areas to determine probabilities of user's current location and possible future locations.

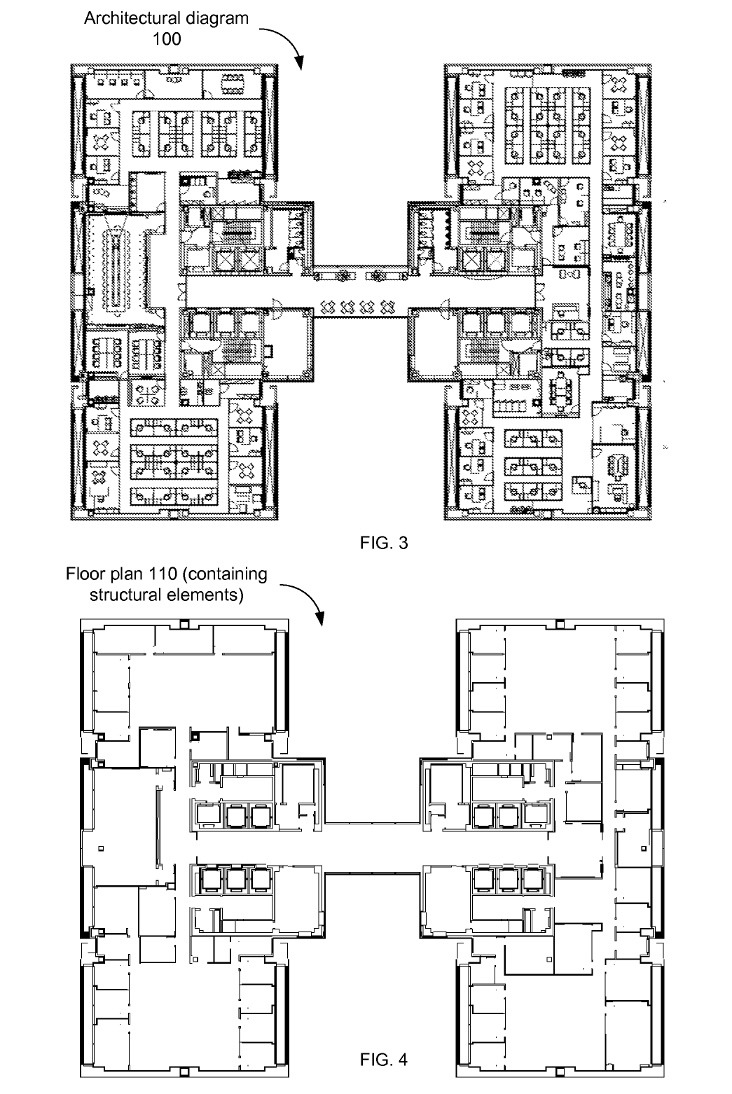

FIGS. 3 and 4 show an example of an architectural diagram 100 and a resulting floor plan 110, in accordance with some embodiments of the present invention. In FIG. 3, an architectural diagram 100 includes several layers shown here as a single image. Most layers show icons and features unnecessary for preparing assistance data 302. These unnecessary icons and features include conference room tables, chairs, desks, door arches and labels.

The layers may be analyzed to determine a probability that that layer contains information useful in creating or developing assistance data 302. For example, layers containing walls are assigned a higher probability that layers containing desks. The layers may then be sorted by probability. The sorted layers may be presented to a user so the user is presented the highest probability layers first. The user may accept the higher layers and possibly look through a few of the higher probability layers to determine if any layer is useful then discard the lower probability layers without viewing the lower probability layers. For example, layers are presented to a user in probability order. The user examines and checks the few layers with the highest probability to create the subset of layers containing the key layers. In this manner, the user spends time considering layers likely to be useful in creating assistance data 302 and no time considering layers unlikely to be useful in creating assistance data 302.

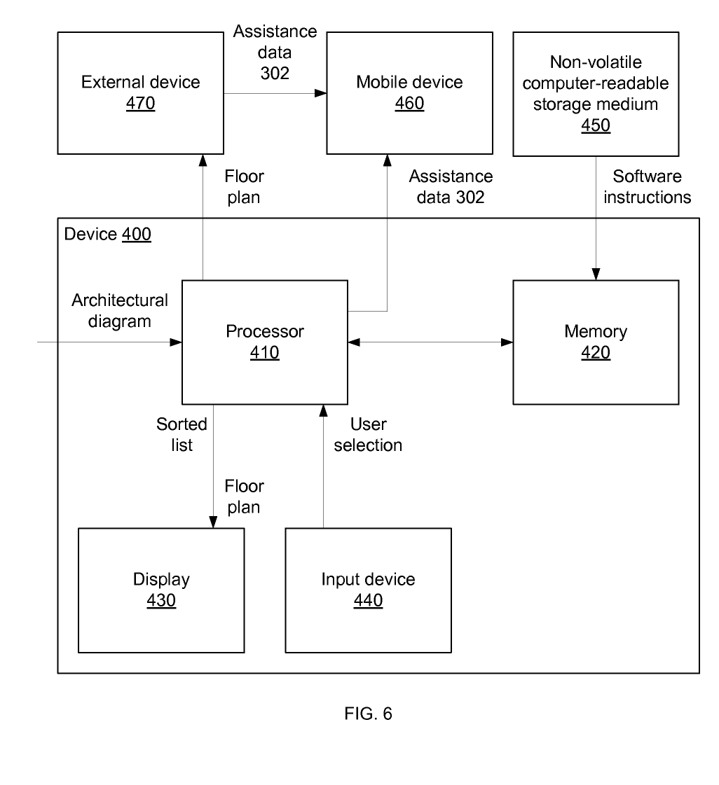

Alternatively, a processor (e.g., processor 410 in FIG. 6) assigns a probability to each layer then takes the layers passing a threshold test (e.g., threshold is 5 layers and top 5 layers are taken; threshold is 90% and all layers having a probability greater than 90% are taken) to create the assistance data 302. In this manner, the process does not need a user to intervene and therefore may be automated.

In FIG. 4, a floor plan 110 is shown with all unnecessary icons and features removed and only structural elements remaining. For example, from a sorted list of layers presented to a user, the user selects the structural layers for creating assistance data 302. Alternatively, a sorted list of layers is filtered by a threshold test to result in the structural layers. By combining the structural layers, a floor plan 110 results with only structural elements.

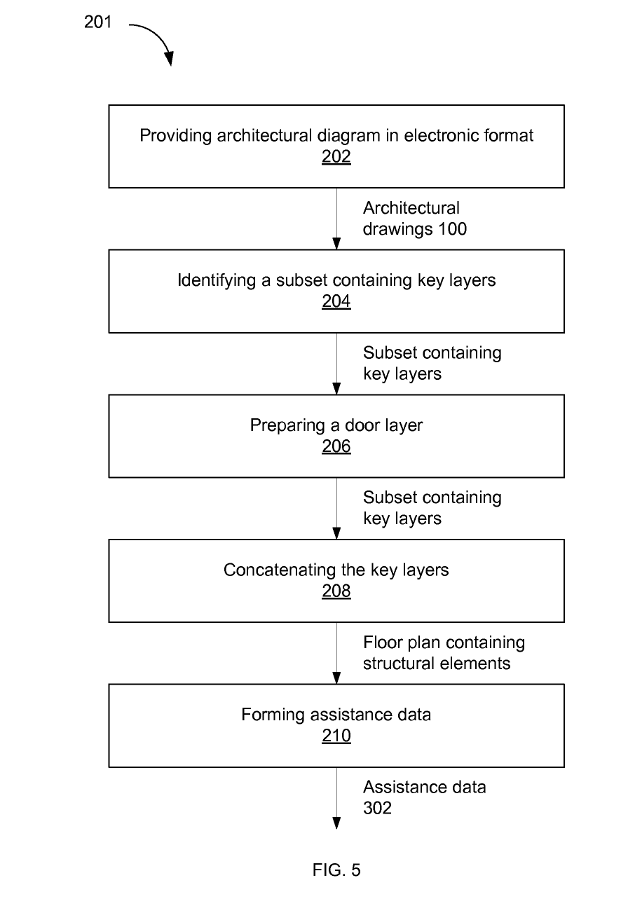

FIG. 5 shows a method 201 to convert an architectural diagram 100 to structural elements for forming assistance data 302, in accordance with some embodiments of the present invention. At 202, the method begins by providing an architectural diagram 100 to a processor (e.g., processor 410 in FIG. 6 in a server or a mobile device). The processor acts as a means for providing the architectural diagram 100 in electronic format. The architectural diagram 100 is in electronic format and contains multiple layers and metadata. The multiple layers could be 50 to 100 or more layers in an architectural diagram format such as a computer-aided design (CAD) format (e.g., AutoCAD format).

At 204, the processor identifies a subset of layers, from the multiple layers, containing key layers. The processor acts as a means for means for identifying the subset containing structural layers from the multiple layers. For example, a layer name of each layer is examined. A layer name may be embedded in the architectural diagram 100 as the metadata and may indicate if the layer is a structural layer. The processor compares the layer name with a list of known layer names. If the layer name is included on a list of a known name, then that layer may be a key layer. For example, a layer may be labeled “Offices.” In this manner, layers may be prioritized as containing walls, doors, elevators and/or stairs.

The processor may analyze and match shapes based on a template to find a structural element. For example, stairs and elevators have a particular signature in terms of the geometrical shapes used to draw them. Alternatively, labels may be used to identify a certain structural elements of the drawing. For example, if the label “STAIRS” or “ELEV” are in a certain region, then it is a higher likelihood that stairs or an elevator is included as a structural element on the drawing.

Automatic identification of structural elements in layers may be used to classify an area type. That is the structural elements inform if the architectural drawing is an office, an airport or a mall. As such, area type classification may be based on geometric shapes (e.g., a jet bridge identified in a drawing usually means the drawing is of an airport. Automatic classification of area type may facilitate application of optimization while generating assistance data.

A hard decision that a layer is relevant or a soft decision that a layer has some probability of being relevant may be made about each layer. For example, a processor may score a likelihood a particular layer may be included or shall be excluded from forming a floor plan 110 containing only structural elements. If the layer is labeled “Desks,” the layer may be excluded under a hard decision or assigned a lower probability under a soft decision as including data useful for forming a floor plan 110.

Alternatively, or in addition to, the processor may compare a maximum span of an object in each layer. This maximum span may be compared to a threshold and if the span is greater than the threshold, the processor scores the layer as including or more likely as a layer including walls. Alternatively, a maximum span may directly convert to a probability a layer is a wall layer. For example, a layer having a maximum span of five feet is set to a lower probability of another layer having a maximum span of 20 feet. A higher or lower probability setting may be set as a score that is adjustable higher if a layer is more likely an important or key layer. If the processor determines that a layer is less likely a key layer, the processor may adjust a score to a lower value. Additionally, the processor may remove labels or other text from the key layers. A user may intervene to confirm one or more layers are wall layers and/or if annotations and labels are properly removed from a layer.

At 206, the processor prepares at least one layer containing a door layer. The processor acts as a means for removing door arches from the door layer in the subset. In preparing the door layer, the processor may determine a layer is a door layer by having a number of door arcs greater than a threshold. That is, the processor searches for door arcs that show a swing of a door. The processor then removes these door arcs and door icons from the door layer. The modified door layer is then added (or re-added) to the subset containing the key layers. In this manner, the processor acts as a means for determining, removing and adding. The key layers may be automatically selecting layers, from the multiple layers, having a threshold or greater probability. Alternatively, a user can select a subset of layers containing the key layers from a sorted list.

Similarly to doors, other known shapes may be removed. A known pattern, such as a chair or desk, may be removed from the drawing. Alternative, a user may select a pattern to remove (like a chair) and the processor automatically removes all like occurrences of that pattern.

At 208, the processor concatenates the key layers to create a floor plan 110 containing the structural elements. The key layers may be fused together to show a clean displayable floor plan 110 containing just structural elements necessary for creating assistance data 302. The processor packages the structural layers for creating assistance data 302. While fusing is helpful to a user observing the floor plan 110, an assistance data 302 generator does not need the layers fused, just concatenated into a single file without the unnecessary layers. At 210, the processor forms the assistance data 302. That is, the floor plan 110 created from an abbreviated list of layers is used to create the assistance data 302. As such, the processor acts as a means for forming the assistance data using the floor plan.

FIG. 6 shows a device 400 to convert an architectural diagram 100 to structural elements for forming assistance data 302, in accordance with some embodiments of the present invention. The device 400 contains a processor 410, memory 420, a display 430 and an input device 440. The device 400 may be coupled to a non-volatile computer-readable storage medium 450, a mobile device 460 and/or an external device 470.

The processor 410 may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof. The processor 410 executes code or software instructions to perform the methods described herein. The processor 410 is coupled to the memory 420. The memory 420 may contain code or software instructions, for example, obtained from the non-volatile computer-readable storage medium 450.

The processor 410 accepts the architectural diagram 100 in electronic format. The architectural diagram 100 contains multiple layers and metadata. The processor 410 identifies a subset of the multiple layers from the architectural diagram 100 containing structural layers. Alternatively, the processor 410 prepares a sorted list of layers in priority or probability order to display on the display 430 to a user. The user uses the input device 440 to make a user selection of what layers from the sorted list should be included in the floor plan 110.

The processor 410 removes door arches from a door layer in the subset. The processor 410 concatenates the subset to create a floor plan 110 containing the structural elements. The processor 410 may provide the user with a floor plan 110 for viewing on the display 430. The processor 410 may remove labels from the subset. The processor 410 or the external device 470 (e.g., a location server) forms the assistance data 302 using the floor plan 110. The processor 410 or the external device 470 sends the assistance data 302 to a mobile device, and therefore acts as a means for sending the assistance data to the mobile device.

The methodologies described herein may be implemented by various means depending upon the application. For example, these methodologies may be implemented in hardware, firmware, software, or any combination thereof. For a hardware implementation, the processing units may be implemented within one or more processor.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory (e.g., memory 420) and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for converting an architectural diagram to structural elements for forming assistance data, the method comprising:
providing the architectural diagram in electronic format, comprising multiple layers and metadata;
identifying a subset containing structural layers from the multiple layers;
removing door arches from a door layer in the subset; and
concatenating the subset to create a floor plan containing the structural elements.

2. The method of claim 1, wherein the architectural diagram contain more than 50 layers.

3. The method of claim 1, wherein identifying the subset containing the structural layers comprises:
comparing a layer name from the metadata with a list of known layer names; and
adjusting a probability if the layer name is in the list of known layer names.

4. The method of claim 1, wherein identifying the subset containing the structural layers comprises:
comparing a span of an object in a layer in the multiple layers to a threshold; and
adjusting a probability if the span is greater than the threshold.

5. The method of claim 1, wherein removing the door arches from the door layer comprises:
determining the door layer has a number of door arcs greater than a threshold;
removing door arcs from the door layer; and
adding the door layer to the subset.

6. The method of claim 1, wherein identifying the subset comprises selecting layers, from the multiple layers, having a probability above a threshold.

7. The method of claim 1, further comprising removing labels from the subset.

8. The method of claim 1, further comprising forming the assistance data using the floor plan.

9. The method of claim 8, further comprising sending the assistance data to a mobile device.

10. A device for converting an architectural diagram to structural elements for forming assistance data, the device comprising a processor and memory comprising code, when executed by the processor, to:
provide the architectural diagram in electronic format, comprising multiple layers and metadata;
identify a subset containing structural layers from the multiple layers;
remove door arches from a door layer in the subset; and
concatenate the subset to create a floor plan containing the structural elements.

11. The device of claim 10, wherein the code to identify the subset containing the structural layers comprises code to:
compare a layer name from the metadata with a list of known layer names; and
adjust a probability if the layer name is in the list of known layer names.

12. The device of claim 10, wherein the code to identify the subset containing the structural layers comprises code to:
compare a span of an object in a layer in the multiple layers to a threshold; and
adjust a probability if the span is greater than the threshold.

13. The device of claim 10, wherein the code to remove the door arches from the door layer comprises code to:
determine the door layer has a number of door arcs greater than a threshold;
remove door arcs from the door layer; and
add the door layer to the subset.

14. The device of claim 10, further comprising code to form the assistance data using the floor plan.

15. The device of claim 14, further comprising code to send the assistance data to a mobile device.

16. A device for converting an architectural diagram to structural elements for forming assistance data, the device comprising:
means for providing the architectural diagram in electronic format, comprising multiple layers and metadata;
means for identifying a subset containing structural layers from the multiple layers;
means for removing door arches from a door layer in the subset; and
means for concatenating the subset to create a floor plan containing the structural elements.

17. The device of claim 16, wherein the means for identifying the subset containing the structural layers comprises:
means for comparing a layer name from the metadata with a list of known layer names; and
means for adjusting a probability if the layer name is in the list of known layer names.

18. The device of claim 16, wherein the means for identifying the subset containing the structural layers comprises:
means for comparing a span of an object in a layer in the multiple layers to a threshold; and
means for adjusting a probability if the span is greater than the threshold.

19. The device of claim 16, wherein the means for removing the door arches from the door layer comprises:
means for determining the door layer has a number of door arcs greater than a threshold;
means for removing door arcs from the door layer; and
means for adding the door layer to the subset.

20. The device of claim 16, further comprising means for forming the assistance data using the floor plan.

21. The device of claim 20, further comprising means for sending the assistance data to a mobile device.

22. A device for converting an architectural diagram to structural elements for forming assistance data comprising a processor and memory wherein the memory includes software instructions to:
provide the architectural diagram in electronic format, comprising multiple layers and metadata;
identify a subset containing structural layers from the multiple layers;
remove door arches from a door layer in the subset; and
concatenate the subset to create a floor plan containing the structural elements.

23. The device of claim 22, wherein the software instructions to identify the subset containing the structural layers includes software instructions to:
compare a layer name from the metadata with a list of known layer names; and
adjust a probability if the layer name is in the list of known layer names.

24. The device of claim 22, wherein the software instructions to identify the subset containing the structural layers includes software instructions to:
compare a span of an object in a layer in the multiple layers to a threshold; and
adjust a probability if the span is greater than the threshold.

25. The device of claim 22, wherein the software instructions to remove the door arches from the door layer includes software instructions to:
determine the door layer has a number of door arcs greater than a threshold;
remove door arcs from the door layer; and
add the door layer to the subset.

26. The device of claim 22, further including software instructions to form the assistance data using the floor plan.

27. The device of claim 26, further including software instructions to send the assistance data to a mobile device.

28. A non-volatile computer-readable storage medium including program code stored thereon for a device for converting an architectural diagram to structural elements for forming assistance data, comprising program code to:
provide the architectural diagram in electronic format, comprising multiple layers and metadata;
identify a subset containing structural layers from the multiple layers;
remove door arches from a door layer in the subset; and
concatenate the subset to create a floor plan containing the structural elements.

29. The non-volatile computer-readable storage medium of claim 28, wherein identifying the subset containing the structural layers comprises:
comparing a layer name from the metadata with a list of known layer names; and
adjusting a probability if the layer name is in the list of known layer names.

30. The non-volatile computer-readable storage medium of claim 28, wherein identifying the subset containing the structural layers comprises:
comparing a span of an object in a layer in the multiple layers to a threshold; and
adjusting a probability if the span is greater than the threshold.

31. The non-volatile computer-readable storage medium of claim 28, wherein removing the door arches from the door layer comprises:
determining the door layer has a number of door arcs greater than a threshold;
removing door arcs from the door layer; and
adding the door layer to the subset.

32. The non-volatile computer-readable storage medium of claim 28, further comprising forming the assistance data using the floor plan.

33. The non-volatile computer-readable storage medium of claim 32, further comprising sending the assistance data to a mobile device.
